(19) United States
(12) Patent Application Publication
(10) Pub. No.: US 2025/0144847 A1
(43) Pub. Date: May 8, 2025

(54) METHOD OF RECYCLING BOTTLES

(71) Applicant: NIAGARA BOTTLING, LLC, Diamond Bar, CA (US)

(72) Inventors: Alan Patricio Ibarra Torres, Monterrey (MX); Jesus Adrian Martinez Medina, Atizapan de Zaragoza (MX)

(21) Appl. No.: 18/940,622

(22) Filed: Nov. 7, 2024

Related U.S. Application Data
(60) Provisional application No. 63/597,147, filed on Nov. 8, 2023.

(51) Int. Cl. B29B 17/04; B29B 17/02; B29L 31/00

(52) U.S. Cl. CPC B29B 17/0412; B29B 17/02; B29B 2017/0217; B29B 2017/044; B29L 2031/7158

(57) ABSTRACT

A slicing station may be configured to divide a container into at least two container portions. The container may include a bottle and a closure secured to the bottle, the bottle including a base, a sidewall, a bell, a finish portion, and a label. The sidewall may include a label portion to which the label is secured. The closure may be secured to the finish portion. A slicing station may include a label remover configured to remove the label from the label portion. A slicing station may include a first slicer configured to remove the closure from the bottle by cutting the bottle. A slicing station may include a second slicer and a third slicer each configured to remove the label portion from the bottle by cutting the bottle.

### CROSS-REFERENCE

This application claims priority to U.S. Provisional Patent Application No. 63/597,147, filed on Nov. 8, 2023, the entire contents of which are incorporated herein by reference.

### FIELD

The present disclosure relates to recycling of plastic bottles.

### BACKGROUND

Polymer bottles are often recycled to save material cost, improve the lifespan of material, etc. However, the polymer bottles are often recycled with contaminants, such as adhesives on the bottle used to secure labels to the bottles. The contaminants can cause the recycled polymer to have a lower quality.

### SUMMARY

In some aspects, the techniques described herein relate to a slicing station for dividing a container into at least two container portions, the container including a bottle and a closure secured to the bottle, the bottle including a base, a sidewall, a bell, a finish portion, and a label, the sidewall including a label portion to which the label is secured, the closure being secured to the finish portion, the slicing station including: a label remover configured to remove the label from the label portion; a first slicer configured to remove the closure from the bottle by cutting the bottle; and a second slicer and a third slicer each configured to remove the label portion from the bottle by cutting the bottle.

In some aspects, the techniques described herein relate to a method of recycling a container, the container including a bottle and a closure secured to the bottle, the bottle including a base, a sidewall, a bell, a finish portion, and a label, the sidewall including a label portion to which the label is secured, the closure being secured to the finish portion, the method including: aligning a first slicer, a second slicer, and a third slicer with the container; removing the label from the bottle; cutting the bottle with the first slicer to separate the closure from the bottle; and cutting the bottle with the second slicer and the third slicer to remove the label portion from the bottle.

Other features and aspects of the disclosure will become apparent by consideration of the following detailed description and accompanying drawings.

### BRIEF DESCRIPTION OF THE DRAWINGS

FIG. 1 is a side view of a container including a bottle, a label, and a closure according to an embodiment of the disclosure.

FIG. 2 is a side view of the container of FIG. 1 with the label removed from the bottle, and with the bottle and the closure aligned with a first slicer.

FIG. 3 is a side view of the container of FIG. 2 with the closure removed and the bottle aligned with a second slicer and a third slicer.

FIG. 4 is a side view of the bottle of FIG. 3 cut into sections.

FIG. 5 is a schematic view of a bottle slicing station according to an embodiment of the disclosure.

FIG. 6 is a flow diagram showing a method of recycling the container of FIG. 1.

FIG. 7 is a side view of the container of FIG. 2 with the bottle and the closure aligned with a first slicer according to another embodiment of the disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

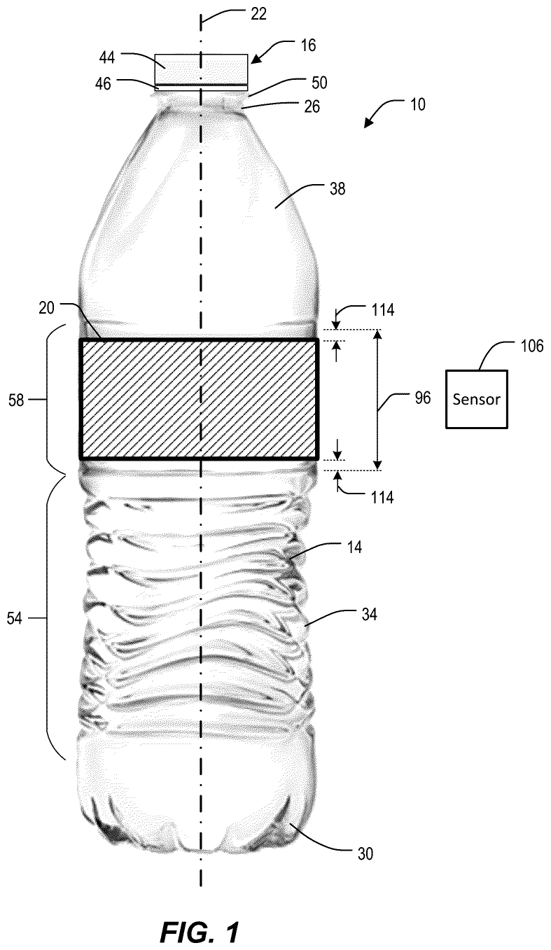

FIG. 1 illustrates a container 10, such as a closed and sealed bottle assembly, including multiple components made of thermoplastic materials (e.g., polyethylene terephthalate (PET), high density polyethylene (HDPE), polypropylene (PP), and the like). The container 10 includes a bottle 14, a closure 16, and a label 20. The bottle 14 can be made from a first material (e.g., PET), the closure 16 can be made from a second material (e.g., HDPE), and the label 20 can be made from a third material (e.g., PP), where the first material, the second material, and the third material are all different materials. The differing materials forming each of these components of the container 10 can present challenges when recycling the container 10.

The bottle 14 is formed as a monolithic body and at least partially defines a storage volume (not shown) and a central axis 22. The bottle 14 includes a finish portion 26, a base 30, and a sidewall 34 connected to and extending from the base 30, and a bell 38 extending between and connecting the finish portion 26 and the sidewall 34. The finish portion 26 is threaded to receive a closure 16 to seal the storage volume. The closure 16 includes a removable portion or cap 44 that is selectively coupled to a tamper evidence band 46 via one or more breakable elements or bridges (not shown). The bridges are breakable to indicate whether the cap 44 has been removed. Prior to removal, the cap 44 is coupled to the tamper evidence band 46 via the bridges. The bridges break in response to the cap 44 being removed from the bottle 14 for the first time. After the cap 44 is removed, the tamper evidence band 46 remains with the bottle 14 and is supported by a support ledge or flange 50 which extends around and protrudes radially from the finish portion 26.

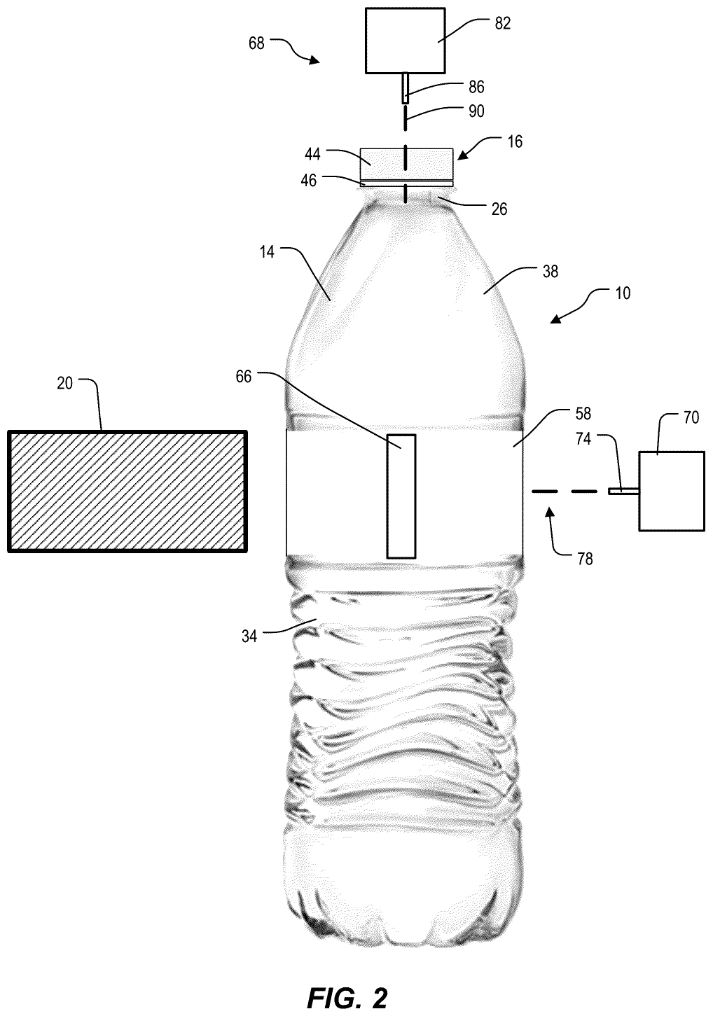

The sidewall 34 includes a grip portion 54 adjacent the base 30 and a label portion 58 adjacent the bell 38. The label portion 58 receives the label 20. In the illustrated embodiment, the label 20 is coupled to the label portion 58 by an adhesive 66 (shown in FIG. 2). In other embodiments (not shown), the label 20 can be coupled to the label portion 58 by other means, such as, e.g., spot welding. The label 20 is made from a material different than that of the bottle 14.

The container 10 is entirely composed of the first material, which is PET in the illustrated embodiment. In other embodiments, the first material can be another thermoplastic material (e.g., PP, polyethylene (PE), polyvinyl chloride (PVC), etc.), while the same principles described herein regarding material purity and recycling still apply. For simplicity, however, the first material will hereafter be referred to as PET.

In some embodiments, the bottle 14 includes 100% PET. In some embodiments, the bottle 14 may be nearly 100% composed of the PET. However, it is desired for the bottle 14 to include a very high percentage of the PET to ensure a high quality bottle 14. Contaminants (i.e., any material different than the PET of the bottle 14) mixed with the PET can cause, for example, the bottle 14 to be less rigid. The PET can include a mixture of virgin PET (i.e., PET that has not been used or processed before) and non-virgin or recycled PET (i.e., PET that has been used or processed before). The bottle 14 can be, for example, composed of 90-95% virgin PET and 5-10% non-virgin PET. Non-virgin PET is created by recycling the PET. For example, non-virgin PET is created by recycling containers (e.g., the bottle 14) composed of the PET. The non-virgin PET can be desirably used in the manufacture of new containers (e.g., the bottle 14) to, for example, decrease a cost associated with producing virgin PET, decrease negative environmental impacts associated with producing virgin PET, etc. However, traditional recycling methods can introduce contaminants to the recycled PET derived from used containers such as the container 10. Said another way, traditional recycling methods can create a mixture of multiple materials mixed with PET. For example, recycling the container 10 according to traditional recycling methods may produce a mixture that includes the first material (i.e., PET) from the bottle 14, the second material (i.e., HDPE) from the closure 16, the third material (i.e., PP) from the label 20, and the adhesive 66. In this example, the HDPE, the PP, and the adhesive 66 can be considered contaminants undesirably mixed with the PET of the bottle 14. The resulting mixture is typically not used to manufacture new containers (i.e., such as a new bottle 14), as the contaminants can cause the material quality to be insufficient. Even if, for example, the closure 16 and the label 20 are removed prior to recycling, the recycled material will still include a mixture of PET and the adhesive 66. The mere presence of the adhesive 66 in this mixture can still render the mixture unsatisfactory for forming a new bottle 14. Accordingly, to maximize the quality of recycled PET derived from recycling the bottle 14, each of the closure 16, the tamper evidence band 46, the label 20, and the adhesive 66 must be separated from the PET material of the bottle 14 prior to recycling the bottle 14.

FIG. 2 illustrates a slicing station 68 operable to separate the bottle 14 into different sections or portions which may then be more easily or more effectively recycled. The slicing station 68 includes a label remover 70 operable to remove the label 20 from the label portion 58 of the bottle 14. In the illustrated embodiment, the label remover 70 is a high pressure sprayer 70. The high pressure sprayer 70 includes a nozzle 74 that sprays a stream 78 (e.g., of water, air, etc.) at high pressure at the label 20 to remove the label 20 from the bottle 14. In some embodiments, the high pressure sprayer 70 can include a plurality of nozzles that each spray a stream to remove the label 20 from the bottle 14. In yet other embodiments, a plurality of label removers can be used to remove the label 20 from the bottle 14. In further embodiments, the label remover 70 can take other forms other than a sprayer and can remove the label by other means. Once the label 20 is removed from the bottle 14, the adhesive 66 remains on the sidewall 34. The illustrated adhesive 66 extends along an entire height of the label portion 58. In other embodiments, the adhesive 66 can extend along one or multiple portions of the label portion 58 but not along its entire height.

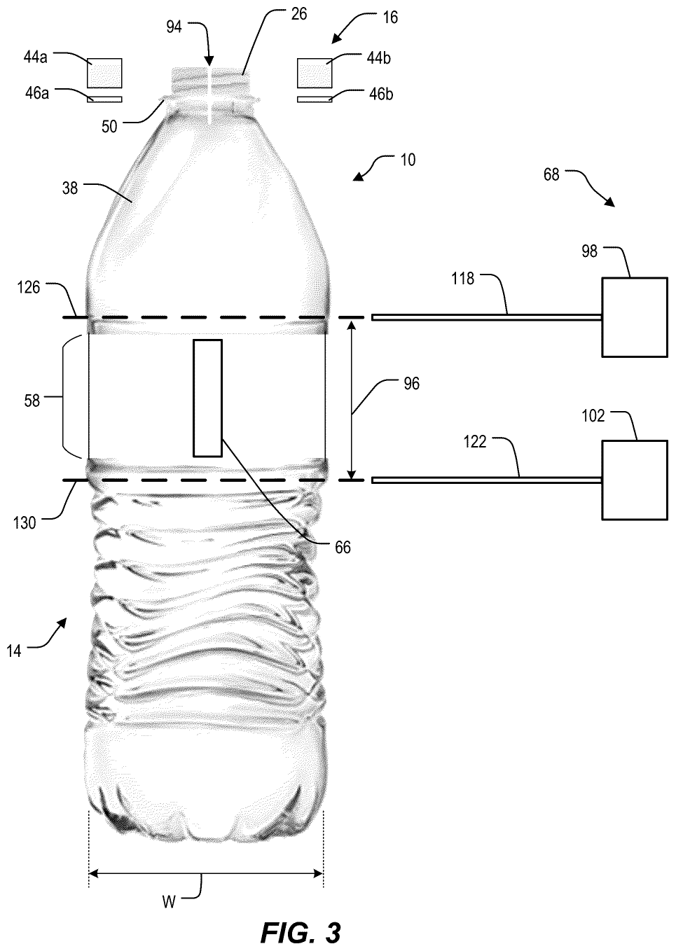

With continued reference to FIG. 2, the slicing station 68 also includes a first slicer 82 which is operable to remove the closure 16 from the bottle 14. The first slicer 82 includes a first blade 86. The illustrated first blade 86 is a static blade. Said another way, the first blade 86 does not rotate. In other embodiments, the first blade 86 can rotate (e.g., like a circular saw). The first blade 86 is configured to move along a first cutting path 90 to cut the closure 16. In the illustrated embodiment, both the cap 44 and the tamper evidence band 46 of the closure 16 are coupled to the bottle 14. The first blade 86 cuts the closure 16 into a first cap portion 44a, a second cap portion 44b, a first band portion 46a, and a second band portion 46b (shown in FIG. 3). In other embodiments, the cap 44 may be missing from the bottle 14, and so the first blade 86 cuts only the tamper evidence band 46 into the first band portion 46a and the second band portion 46b. In other embodiments, the first blade 86 may cut the cap 44 and the tamper evidence band 46 into more portions (e.g., three, four, etc.). The first cutting path 90 extends through the finish portion 26. In the illustrated embodiment, the first cutting path 90 extends past the flange 50 and into the bell 38. In other embodiments, the first cutting path 90 can extend further or less into the bottle 14. However, the first cutting path 90 should extend through the closure 16 and the tamper evidence band 46. As such, the first blade 86 is configured to move along the first cutting path 90 to cut all of the closure 16 including the cap 44 and the tamper evidence band 46. The illustrated first cutting path 90 is parallel with the central axis 22 of the bottle 14. More specifically, the first cutting path 90 is coincident with the central axis 22.

With reference to FIG. 3, after the first blade 86 travels along the first cutting path 90 the bottle 14 includes a first slice 94. The illustrated first slice 94 extends through the finish portion 26 and into the bell 38. The first and second cap portions 44a, 44b and the first and second band portions 46a, 46b subsequently fall off the bottle 14. In some embodiments, the first and second cap portions 44a, 44b and the first and second band portions 46a, 46b can be forcibly removed from the bottle 14 (e.g., by pressurized air, by pressurized water, by vibrating the bottle 14, etc.). Once removed, the cap portions 44a, 44b and the band portions 46a, 46b can be collected and recycled to form, e.g., new closures 16 made of the second material (e.g., HDPE).

With continued reference to FIG. 3, the bottle 14 includes an adhesive portion 96 on which the adhesive 66 is located (or, at least likely to be located). To ensure that the adhesive 66 is not recycled with the PET of the bottle 14, which could contaminate the PET and render it unfit or at least undesirable for forming a new bottle, the adhesive portion 96 of the bottle 14 may be cut away and removed from the bottle 14. In some embodiments, the adhesive portion 96 can include all or part of the label portion 58, while in other embodiments, the adhesive portion 96 can include all of the label portion 58 and portions of the bell 38 and/or the grip portion 54.

With reference to FIG. 1, the slicing station 68 may also optionally include a sensor 106 that is operable to detect a location of the adhesive portion 96. The sensor 106 senses a location of the label 20 prior to the label removal step and uses the location of the label 20 as a proxy for the location of the adhesive 66. Once the sensor 106 determines the location of the label 20, a predetermined distance 114 (measured along a direction parallel to the central axis 22) can be added on to each side of the label 20. The predetermined distance 114 can be added to account for any error in application of the adhesive 66. Said another way, during manufacturing of the container 10, the adhesive 66 may extend past where the label 20 is applied. Accordingly, the predetermined distance 114 ensures that the removed adhesive portion 96 includes all of the adhesive 66. The predetermined distance 114 can be, for example, 3 millimeters, 5 millimeters, etc. In some embodiments, there may be no predetermined distance added to each side of the label 20. In other embodiments, the sensor 106 can use a different feature of the container 10 as a proxy for the location of the adhesive 66, or the sensor 106 can directly detect the location of the adhesive 66. In yet other embodiments, the sensor 106 can detect a size of the bottle 14. Said another way, the sensor 106 can detect a height of the bottle 14 and a diameter of the bottle 14 (or a plurality of diameters along the height). The detected height and/or diameter can be used to determine the location of the adhesive portion 96.

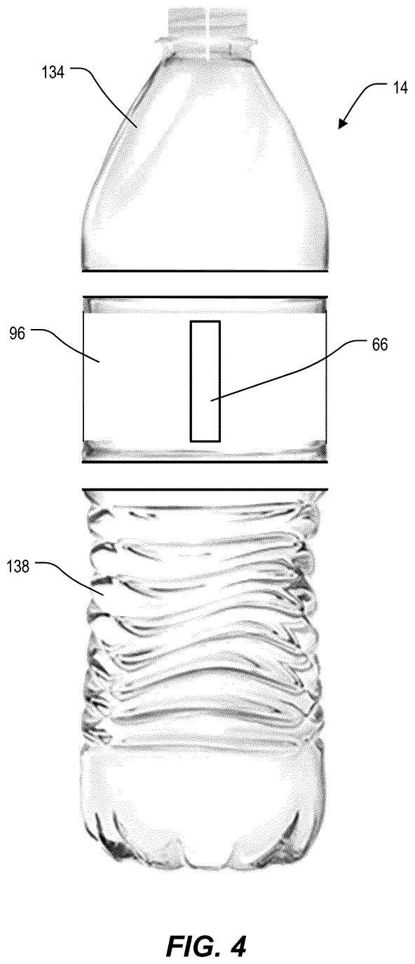

With reference again to FIG. 3, the slicing station 68 also includes a second slicer 98 and a third slicer 102 which are operable to remove the adhesive portion 96 from the bottle 14. The second slicer 98 includes a second blade 118. The third slicer 102 includes a third blade 122. In the illustrated embodiment, the second and third slicers 98, 102 (and the second and third blades 118, 122) are identical. In other embodiments, the second and third slicers 98, 102 and/or the second and third blades 118, 122 can have a different shape or size. The second and third blades 118, 122 are static blades. Said another way, the second and third blades 118, 122 do not rotate. In other embodiments, the second and third blades 118, 122 can rotate (e.g., like a circular saw). The second and third blades 118, 122 are larger than the first blade 86 (shown in FIG. 2). The illustrated second and third blades 118, 122 are larger than a width W of the bottle 14. As such, the second and third blades 118, 122 are large enough to cut entirely through the bottle 14. The second blade 118 is configured to move along a second cutting path 126 to cut the bottle 14. The third blade 122 is configured to move along a third cutting path 130 to cut the bottle 14. The second and third cutting paths 126, 130 are parallel with each other. The second and third cutting paths 126, 130 are transversely oriented relative to the central axis 22 (shown in FIG. 1). More specifically, the second and third cutting paths 126, 130 are oriented perpendicular with the central axis 22. The second and third cutting paths 126, 130 are defined by edges of the adhesive portion 96. Said another way, the second and third cutting paths 126, 130 are aligned with upper and lower boundaries of the adhesive portion 96. As such, when the second and third blades 118, 122 move along the second and third cutting paths 126, 130, respectively, the second and third blades 118, 122 remove the adhesive portion 96 from the bottle 14. After the second and third blades 118, 122 respectively travel along the second and third cutting paths 126, 130 the bottle 14 is segmented into the adhesive portion 96, an upper portion 134, and a lower portion 138 (shown in FIG. 4).

With reference to FIG. 4, the adhesive portion 96 is separated from the upper and lower portions 134, 138. The adhesive 66 is entirely located on the adhesive portion 96. Said another way, there is no adhesive 66 on the upper or lower portions 134, 138. The upper and lower portions 134, 138 are entirely composed of the PET. The upper and lower portions 134, 138 do not include any contaminants. As such, the upper and lower portions 134, 138 can be, for example, ground up and subsequently reused (e.g., manufactured into new containers). The adhesive portion 96 can be ground up separately from the upper and lower portions 134, 138 and recycled for other applications where the presence of the adhesive 66 mixed with the first material of the bottle 14 (i.e., PET) may be tolerable. Or, the adhesive portion 96 can be ground up, for example, with the first and second cap portions 44a, 44b and the first and second band portions 46a, 46b (shown in FIG. 3). Or, the adhesive portion 96 can be subsequently reused for a different application.

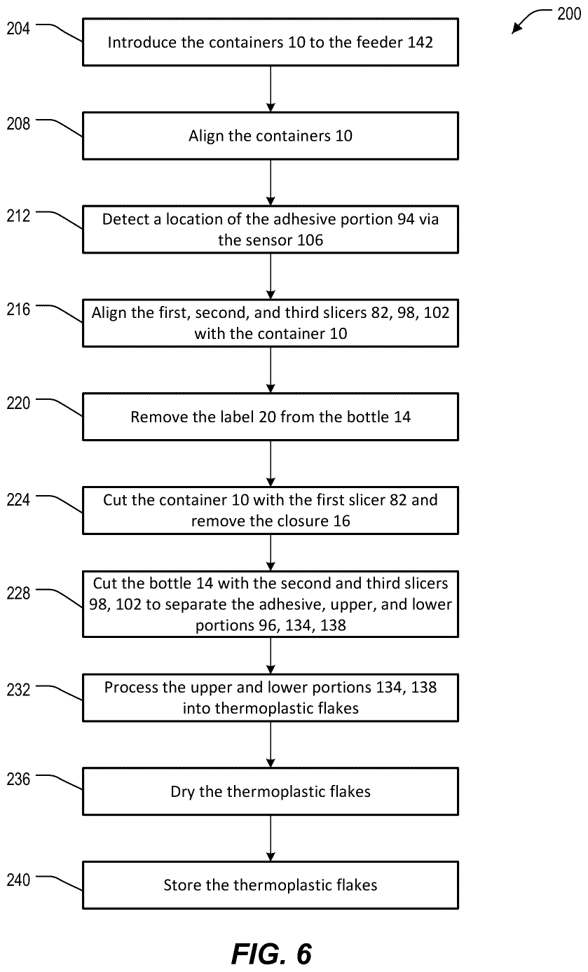

FIG. 6 schematically illustrates the slicing station 68 operable to perform many steps of recycling the container 10. The slicing station 68 includes the high pressure sprayer 70, the first slicer 82, the second slicer 98, the third slicer 102, and the sensor 106. The slicing station 68 also includes a feeder 142 which prepares a plurality of the containers 10 for subsequent processing. For example, the feeder 142 can hold the containers 10 in a bowl. The feeder 142 can, for example, push the containers 10 along an assembly line. The slicing station 68 also includes a controller 154 operable to receive and transmit signals and commands to and from the components of the slicing station 68. The controller 154 includes a memory 158 for storing software, logic, algorithms, programs, a set of instructions, etc. for controlling the high pressure sprayer 70, the slicers 82, 98, 102, the sensor 106, and the feeder 142. The controller 154 also includes a processor 162 for carrying out or executing the software, logic, algorithms, programs, a set of instructions, etc.

FIG. 6 depicts a method 200 of recycling the container 10. The method 200 is illustrated in FIG. 6 as a plurality of instructions or steps that are depicted in flow diagram form. The method 200 begins at step 204, where a plurality of the containers 10 are collected and inserted into the feeder 142. The feeder 142 can be a manual feeder or an automatic feeder.

Next, at step 208, the containers 10 are aligned. Said another way, the containers 10 are organized for subsequent processing. The containers 10 can be oriented such that the base 30 of each container 10 contacts a support surface (e.g., of the assembly line). The containers 10 can also, for example, be organized in a single file line.

Next, at step 212, the sensor 106 detects the location the adhesive portion 96 on each container 10. In one non-limiting embodiment, as discussed in detail above, the sensor 106 detects the location of the label 20 as a proxy for the location of the adhesive 66. The predetermined distance 114 is then added to each side of the label 20. For example, the predetermined distance 114 can be 3 millimeters.

Next, at step 216, the first, second, and third slicers 82, 98, 102 are oriented based on the size of the container 10 and/or the location of the adhesive portion 96. If adjacent containers 10 have different dimensions, the first, second, and third slicers 82, 98, 102 are adjusted to properly remove the respective adhesive portions 96. The time to adjust the slicers 82, 98, 102 is an adjustment time. Containers 10 are not processed during the adjustment time. As such, it is desired to minimize or eliminate the adjustment time by using similar shaped containers 10. If the plurality of containers 10 are, for example, identical, the adjustment time can be eliminated. As such, the method 200 is preferably performed using only similarly or identically shaped containers 10.

Next, at step 220, the labels 20 are removed from the containers 10. The nozzle 74 of the label remover 70 sprays the stream 78 at each label 20 until it is removed from the bottle 14. The label 20 is removed from each bottle 14 to prevent the material of the label 20 from contaminating the PET of the bottle 14 during recycling. In further embodiments, the label remover 70 can take other forms other than a sprayer and can remove the label by other means.

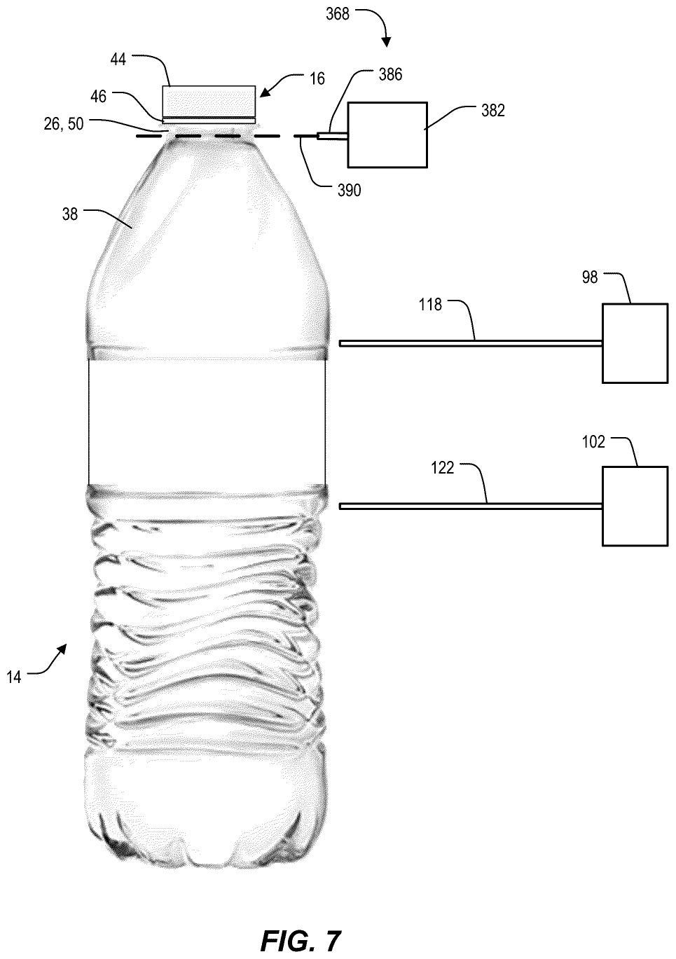

Next, at step 224, the closure 16 is removed from the bottle 14. The first slicer 82 moves the first blade 86 along the first cutting path 90 and through the closure 16. Accordingly, the first blade 86 cuts the closure 16 into the first and second cap portions 44a, 44b and the first and second band portions 46a, 46b. The first blade 86 also cuts the first slice 94 into the bottle 14. In other embodiments, such as that described herein with respect to FIG. 7, the first slicer 382 moves the first blade 386 along the cutting path 390 to separate the finish portion 26, the cap 44, and the tamper evidence band 46 from the bell 38.

Next, at step 228, the adhesive portion 96 is removed from the bottle 14. The second and third blades 118, 122 of the second and third slicers 98, 102 are already aligned with the adhesive portion 96. As such, the second and third slicers 98, 102 extend the second and third blades 118, 122 along the second and third cutting paths 126, 130, respectively. The second and third blades 118, 122 can simultaneously cut the bottle 14 to remove the adhesive portion 96. Alternatively, the second and third blades 118, 122 can sequentially cut the bottle 14 to remove the adhesive portion 96. For example, the second blade 118 can first cut the bottle 14 along the second cutting path 126 to remove the upper portion 134 from the adhesive portion 96 and the lower portion 138. The third blade 122 can subsequently cut the bottle 14 along the third cutting path 130 to separate the adhesive portion 96 and the lower portion 138. At the end of step 228, the adhesive, upper, and lower portions 96, 134, 138 are separated.

Next, at step 232, the upper and lower portions 134, 138 are isolated from the adhesive portion 96. For example, the upper and lower portions 134, 138 can travel along a first conveyor belt to a first location, and the adhesive portion 96 can travel along a second conveyor belt to a second location. The upper and lower portions 134, 138 are then shredded into thermoplastic flakes or shavings formed from the first material (i.e., PET). The thermoplastic flakes do not include contaminants. The thermoplastic flakes are collected in a first container. The adhesive portion 96 can also be shredded into scrap flakes (not shown). In some embodiments, at least one of the first and second cap portions 44a, 44b, the first and second band portions 46a, 46b, and the label 20 can be shredded with the adhesive portion 96 into the scrap flakes. The scrap flakes contain contaminants and are collected in a second container.

Next, at step 236, the thermoplastic flakes are dried by a drying system (e.g., an oven, heated lamps, etc.). The thermoplastic flakes can be wet, for example, due to water sprayed by the high pressure sprayer 70 to remove the label 20. The drying system heats up the thermoplastic flakes to a drying temperature. The drying temperature can be, for example, 180 degrees Celsius. The drying temperature is a temperature that does not damage the thermoplastic flakes. If the thermoplastic flakes are heated to too high of a temperature, the thermoplastic flakes can be damaged. Damage to the thermoplastic flakes can cause, for example, chemicals to leak from the thermoplastic flakes or any item (e.g., containers 10) subsequently manufactured with the thermoplastic flakes. The thermoplastic flakes are heated at the drying temperature until the liquid evaporates from the thermoplastic flakes. The scrap flakes can also be dried similar to the thermoplastic flakes.

Next, at step 240, the thermoplastic flakes are stored until they are needed for manufacturing. The thermoplastic flakes can be subsequently manufactured to create new containers similar to the containers 10. Alternatively, the thermoplastic flakes can be used to manufacture other items composed of the PET. The steps 204-240 can be subsequently repeated with the newly manufactured containers.

FIG. 7 illustrates aspects of a slicing station 368 according to another embodiment. The slicing station 368 is also operable to separate the bottle 14 into different sections or portions which may then be more easily or more effectively recycled. The slicing station 368 is similar to the slicing station 68 described herein but includes the following differences.

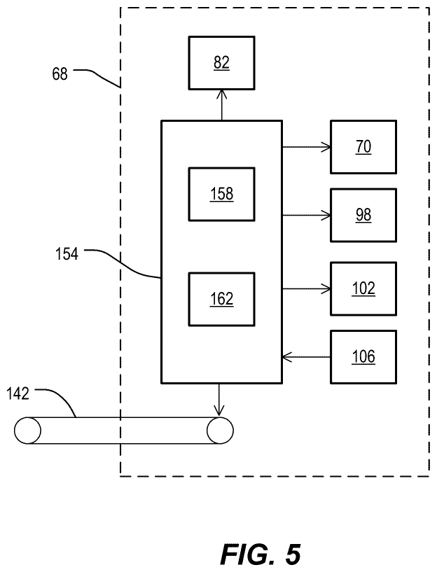

The slicing station 368 includes a first slicer 382 which is operable to remove the closure 16 from a remainder of the bottle 14. The first slicer 382 includes a first blade 386 which moves along a first cutting path 390 to separate the finish portion 26 from the bell 38. The finish portion 26, the flange 50, the cap 44, and the tamper evidence band 46 may then all be removed from a remainder of the bottle 14 and discarded, or otherwise separately processed and/or recycled. Aside from the aforementioned first slicer 382, the slicing station 368 may otherwise be substantially similar to the slicing station 68 described herein and may include the label remover 70, the second and third slicers 98, 102, the sensor 106, and the controller 154 (FIG. 5).

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A slicing station for dividing a container into at least two container portions, the container including a bottle and a closure secured to the bottle, the bottle including a base, a sidewall, a bell, a finish portion, and a label, the sidewall including a label portion to which the label is secured, the closure being secured to the finish portion, the slicing station comprising:
a label remover configured to remove the label from the label portion;
a first slicer configured to remove the closure from the bottle by cutting the bottle; and
a second slicer and a third slicer each configured to remove the label portion from the bottle by cutting the bottle.

2. The slicing station of claim 1, wherein:
the first slicer includes a first blade configured to cut the bottle between the bell and the finish portion;
the second slicer includes a second blade configured to cut the sidewall at a first location that is a first predetermined distance above a first boundary of the label portion; and
the third slicer includes a third blade configured to cut the sidewall at a second location that is a second predetermined distance below a second boundary of the label portion.

3. A method of recycling a container, the container including a bottle and a closure secured to the bottle, the bottle including a base, a sidewall, a bell, a finish portion, and a label, the sidewall including a label portion to which the label is secured, the closure being secured to the finish portion, the method comprising:
aligning a first slicer, a second slicer, and a third slicer with the container;
removing the label from the bottle;
cutting the bottle with the first slicer to separate the closure from the bottle; and
cutting the bottle with the second slicer and the third slicer to remove the label portion from the bottle.

4. The method of claim 3, wherein:
cutting the bottle with the first slicer includes cutting bottle between the bell and the finish portion;
cutting the bottle with the second slicer includes cutting the sidewall at a first location that is a first predetermined distance above a first boundary of the label portion; and
cutting the bottle with the third slicer includes cutting the sidewall at a second location that is a second predetermined distance below a second boundary of the label portion.
